(19) United States
(12) Patent Application Publication
(10) Pub. No.: US 2005/0091868 A1
(43) Pub. Date: May 5, 2005

(54) Machine with vibrating tank for drying and polishing cutlery

(75) Inventor: Romeo Nicetto, Senago (IT)

Correspondence Address: MODIANO & ASSOCIATI, Via Meravigli, 16, MILANO, 20123, IT

(73) Assignee: NICEM S.p.A.

(21) Appl. No.: 10/962,563

(22) Filed: Oct. 13, 2004

(30) Foreign Application Priority Data
Oct. 17, 2003 (IT) MI2003A002026

(51) Int. Cl. F26B 25/00

(52) U.S. Cl. 34/218

(57) ABSTRACT

A machine with vibrating tank for drying and polishing cutlery, comprising a support and containment structure that supports elastically a treatment tank for containing a drying and polishing material. The treatment tank is actuatable with a vibrating motion and is connected to a port for loading the cutlery to be dried and polished and to a port for unloading the dried and polished cutlery, and has a circular plan shape being provided internally with a rising channel that is arranged helically around the axis of the treatment tank from the bottom of the tank to the unloading port. The loading port is spaced laterally from the axis of the treatment tank.

### BACKGROUND OF THE INVENTION

The present invention relates to a machine with vibrating tank for drying and polishing cutlery.

Machines for drying and polishing cutlery after washing are known. These machines are generally constituted by a support and containment structure, which is usually shaped substantially like a parallelepiped and supports, by way of springs, a treatment tank that is designed to contain a drying and polishing material and the cutlery to be treated. A motorized vibrating unit is connected to the treatment tank and is usually constituted by an electric motor with eccentric masses, which can be operated in order to vibrate the treatment tank so that as a consequence of this vibration the drying and polishing material interacts with the cutlery, drying and polishing it.

The treatment tank is open in an upper region and is provided internally with a rising channel that protrudes from the bottom of the treatment tank to an outlet that is formed proximate to the top of the treatment tank and is connected to an unloading port. The cutlery to be dried is introduced into the treatment tank through a loading port, which is generally formed in the upper wall of the support and containment structure that lies above the treatment tank. As a consequence of the vibration to which the treatment tank is subjected, the cutlery, introduced into the treatment tank, gradually advances, together with the drying and polishing material, along the rising channel until it reaches the unloading port, through which it is unloaded, now dry and polished. The last portion of the rising channel is perforated so as to separate the drying and polishing material from the cutlery before it is unloaded outside the treatment tank.

These conventional types of machine generally have a treatment tank that has a square plan shape, and the loading port is usually arranged in a central region of the upper wall of the support and containment structure above the treatment tank. As a consequence of this configuration in the treatment tank and of this arrangement of the loading port, unwanted accumulations of cutlery can occur along the duct that connects the loading port to the bottom of the treatment tank and/or to the inside of the treatment tank. These accumulations hinder the correct flow of the cutlery during loading and/or during treatment inside the tank.

Moreover, the arrangement of the loading port in a central region of the treatment tank determines a bulk, on the upper wall of the support and containment structure, that makes it difficult to load the cutlery, because it does not allow full use of the upper face of the support and containment structure as a supporting surface for the container of the cutlery to be treated.

### SUMMARY OF THE INVENTION

The aim of the present invention is to solve the problems noted above by providing a machine with vibrating tank for drying and polishing cutlery that does not cause unwanted accumulations of cutlery inside the duct that connects the loading port to the bottom of the treatment tank and/or inside the treatment tank.

Within this aim, an object of the invention is to: provide a machine that allows a gradual and uniform advancement of the cutlery toward the unloading port, also achieving higher effectiveness in drying and polishing.

A further object of the invention is to provide a machine that makes cutlery loading and unloading particularly easy.

A further object of the invention is to provide a machine that offers maximum assurances of hygiene as regards the cutlery drying and polishing treatment.

This aim and these and other objects that will become better apparent hereinafter are achieved by a machine with vibrating tank for drying and polishing cutlery, comprising a support and containment structure that supports elastically a treatment tank adapted to contain a drying and polishing material, said treatment tank being actuatable with a vibrating motion and being connected to a port for loading the cutlery to be dried and polished and to a port for unloading the dried and polished cutlery, characterized in that said treatment tank has a circular plan shape, with a substantially vertical axis, and is provided internally with a rising channel that is arranged helically around the axis of said treatment tank from the bottom of said treatment tank to said unloading port, and in that said loading port is spaced laterally from the axis of said treatment tank.

### BRIEF DESCRIPTION OF THE DRAWINGS

Further characteristics and advantages of the invention will become better apparent from the description of a preferred but not exclusive embodiment of the machine according to the invention, illustrated by way of nonlimiting example in the accompanying drawings, wherein:

FIG. 1 is a front view of the machine according to the invention;

FIG. 2 is a top plan view of the machine according to the invention;

FIG. 3 is a sectional view of FIG. 2, taken along the line III-III;

FIG. 4 is a sectional view of FIG. 3, taken along the line IV-IV;

FIG. 5 is a sectional side view of the machine according to the invention, taken along a vertical plane.

### DESCRIPTION OF THE PREFERRED EMBODIMENTS

With reference to the figures, the machine according to the invention, generally designated by the reference numeral 1, comprises a support and containment structure 2, which is preferably substantially shaped like a parallelepiped with a front wall 2a, a rear wall 2b, two side walls 2c and 2d, a bottom wall 2e, and an upper wall 2f;

The support and containment structure 2 is preferably mounted on wheels 3 in order to allow easy movement of the machine.

The support and containment structure 2 supports internally a treatment tank 4, which is suspended on springs 5 that are interposed between two horizontal cross-members 6a and 6b of the support and containment structure 2 and the bottom of the treatment tank 4. A motorized vibrating unit 7 is connected to the bottom of the treatment tank 4, in a central region, and can be constituted in a per se known manner by an electric motor with eccentric masses, which can be actuated in order to vibrate the treatment tank 4 with respect to the support and containment structure 2.

The treatment tank 4 is connected to a loading port 8, through which it is possible to insert in the treatment tank 4 the cutlery to be dried and polished, and to an unloading port 9, through which the dried and polished cutlery is unloaded outside the treatment tank 4.

According to the invention, the treatment tank 4 has a circular plan shape with a vertical axis 4a, and is provided with an inlet 10, which is formed on a portion of its cylindrical lateral surface and is connected to the loading port 8, and with an outlet 11, which is formed again on a portion of its cylindrical lateral surface proximate to its upper end and is connected to the unloading port 9. In the treatment tank 4 a rising channel 12 is provided, which is arranged helically around the axis 4a from the bottom of the treatment tank 4 to the outlet 11. The loading port 8 is spaced laterally with respect to the axis 4a of the treatment tank 4.

More particularly, the loading port 8 is connected to the inlet 10 through a loading duct 13, which is fixed to a lateral portion of the cylindrical surface of the treatment tank 4 at the inlet 10. The loading port 8 is connected to the loading duct 13 preferably by means of a hopper 14.

As in the illustrated example, the loading port 8 can be formed in a lateral region of the upper wall 2f of the support and containment structure 2, with the hopper accommodated in said support and containment structure 2.

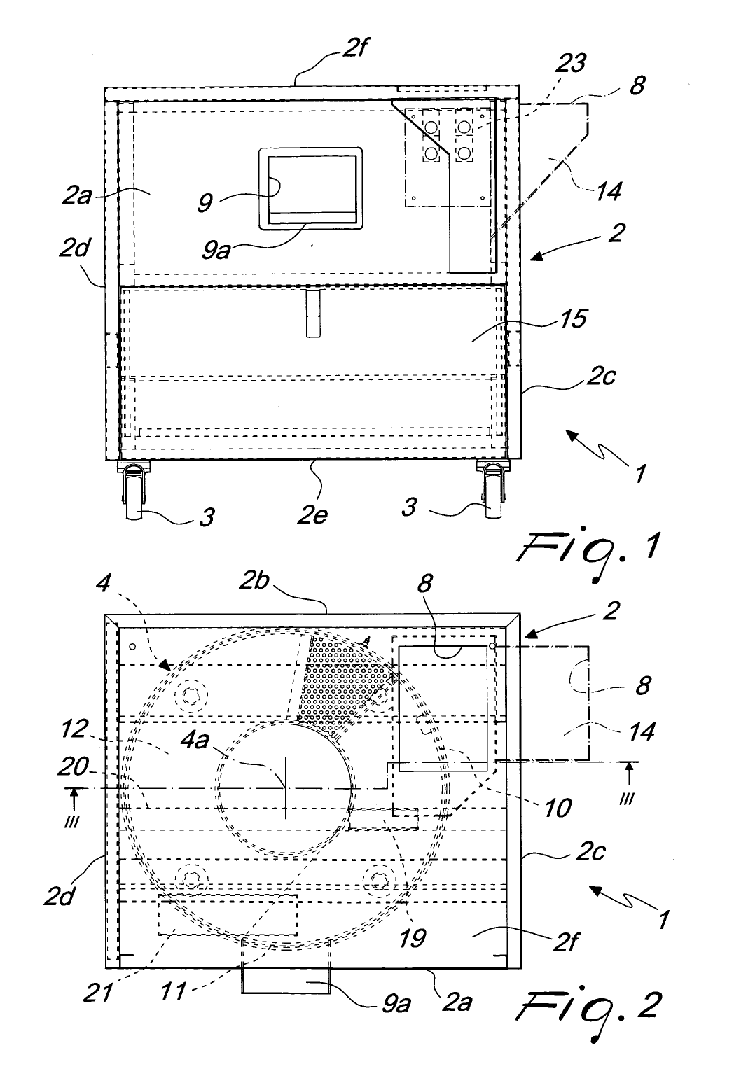

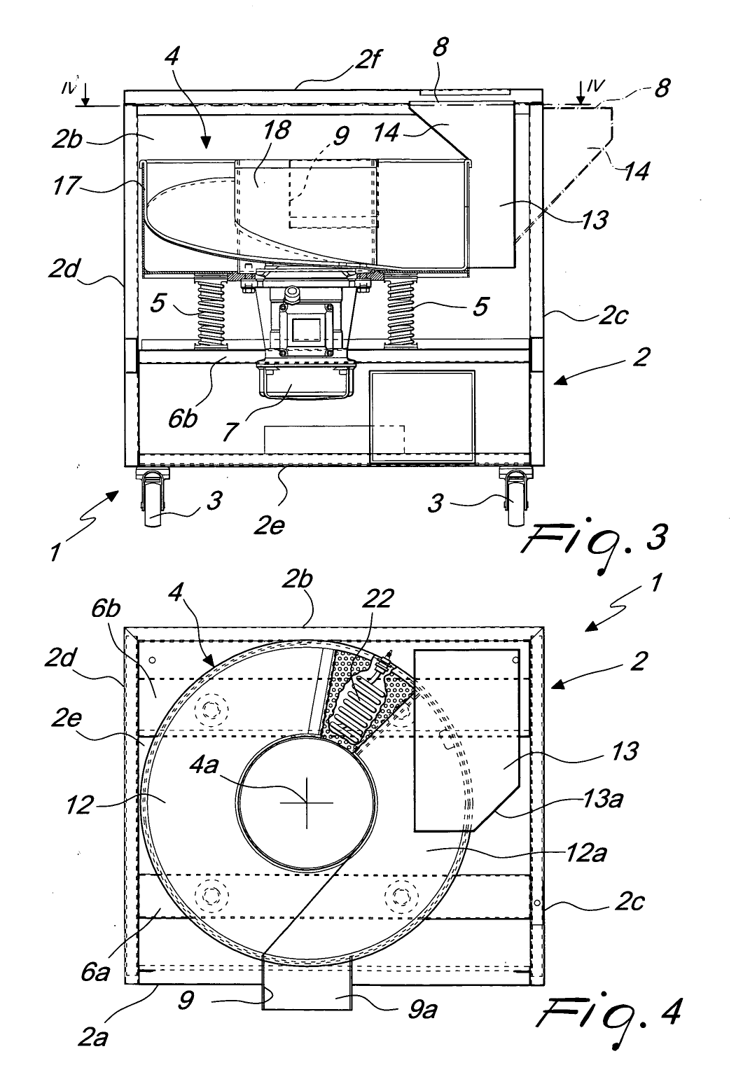

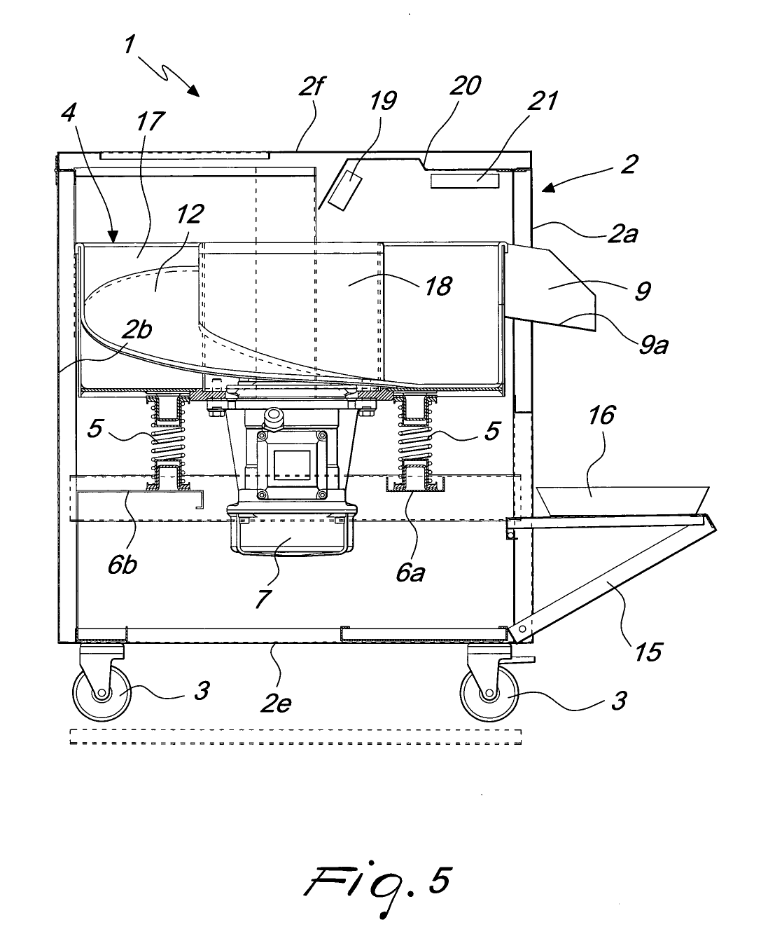

As an alternative, as shown in dashed lines in FIGS. 2 and 3, the loading port 8, with the hopper 14, can be arranged on a side wall of the support and containment structure 2, which is constituted, in the illustrated case, by the side wall 2c, externally to the support and containment structure 2.

The loading duct 13 has a flat bottom, which is substantially co-planar to the bottom of the treatment tank 4, and is laterally blended with the cylindrical surface of the treatment tank 4 by a wall 13a that is arranged on a plane that is substantially tangent to the cylindrical surface of the treatment tank 4.

The unloading port 9, provided with an appropriately provided chute 9a, is preferably formed on the front wall 2a of the support and containment structure 2, in an upper central region of said front wall 2a.

Preferably, the front wall 2a of the support and containment structure 2 has a flap 15, which can be tilted up below the unloading port 9 so as to form a substantially horizontal supporting surface for a container 16 for collecting the cutlery in output from the unloading port 9.

The treatment tank 4 is substantially cylindrical, is open in an upward region and is delimited by a bottom wall, by an outer cylinder 17, and by an inner cylinder 18, which rise from the bottom wall coaxially to each other and between which the rising channel 12 is arranged.

The end portion 12a of the rising channel 12 is at least partially perforated and lies on a plane that is substantially perpendicular to the axis 4a of the treatment tank 4.

Proximate to the end portion 12a of the rising channel 12, the support and containment structure 2 supports a fan 19, which can be actuated so as to affect, with a stream of air that is orientated away from the outlet 11, the cutlery and the drying and polishing material arranged on the end portion 12a of the rising channel 12.

More particularly, inside the support and containment structure 2, above the treatment tank 4, a plate 20 is arranged so as to partially cover the treatment tank 4. A fan 19 is connected below said plate 20, is constituted for example by a centrifugal fan, and is orientated so as to affect in countercurrent the cutlery and the drying and polishing material that advance along the channel 12 toward the unloading port 9.

Conveniently, the machine according to the invention is provided with means for sterilizing the cutlery and the drying and polishing material. Said sterilization means are preferably constituted by an ultraviolet lamp 21, which faces in an upward region the treatment tank 4 and can also be connected to the lower face of the plate 20.

The machine according to the invention is also provided with means for heating the drying and polishing material. Said heating means can be constituted by an electric resistor 22, which is arranged inside the treatment tank 4. The electric resistor 22 is arranged below the perforated end portion 12a of the rising channel 12, above the level of the drying and polishing material, so as to heat the drying and polishing material as it falls from the end portion 12a without remaining for a long time in contact with said material in order to avoid overheating it.

Preferably, the treatment tank 4, and the other parts adapted to make contact with the cutlery, are made of stainless steel or are made of, and/or coated with, a material that is suitable for contact with food products.

The control panel 23 for controlling the operation of the machine is arranged preferably on the front wall 2a.

The operation of the machine according to the invention is as follows.

The drying and polishing material, preferably constituted by corncob, is arranged inside the treatment tank 4.

This drying and polishing is gradually heated by the electric resistor 22. The cutlery to be dried and polished is introduced into the treatment tank 4 through the loading port 8. It should be noted that the particular position of the loading port 8, off-center with respect to the treatment tank 4, makes it particularly easy to load the cutlery, because it allows, during this operation, to rest the container of the wet cutlery on the upper wall 2f of the support and containment structure 2.

The cutlery introduced into the treatment tank 4, through the loading duct 13, reaches the bottom of the treatment tank 4 which, by vibrating due to the actuation of the motorized vibrating unit 7, produces the gradual advancement of the cutlery and of the drying and polishing material along the rising channel 12 toward the unloading port 9. During this advancement, the cutlery is subjected to the action of the drying and polishing material.

In the end portion 12a of the channel 12, the drying and polishing material falls below the end portion 12a, while the cutlery continues toward the unloading port 9., The air stream generated by the fan 19 propels any residues of drying and polishing material toward the inside of the treatment tank 4, preventing it from being unloaded together with the cutlery through the unloading port 9.

The dried and polished cutlery is unloaded through the unloading port 9 and falls into the appropriately provided container 16, which is arranged below the unloading port 9 and rests on the surface formed by the tilted-up flap 15.

During the drying and polishing treatment, the cutlery and the drying and polishing material are constantly sterilized by the action of the lamp 21.

In practice it has been observed that the machine according to the invention fully achieves the intended aim, since the shape of the treatment tank and the arrangement of the loading port effectively avoid the accumulation of cutlery in its travel from the loading port to the unloading port.

Moreover, again thanks to the particular arrangement of the loading port, it is particularly easy to load the cutlery to be dried and polished.

The machine thus conceived is susceptible of numerous modifications and variations within the scope of the appended claims; all the details may be replaced with other technically equivalent elements.

In practice, the materials used, so long as they are compatible with the specific use, although preference is given to the use of stainless steel and/or of materials suitable for contact with food products for the parts that are meant to make contact with the cutlery, as well as the dimensions, may be any according to requirements and to the state of the art.

The disclosures in Italian Patent Application No. MI2003A002026 from which this application claims priority are incorporated herein by reference.

1. A machine with vibrating tank for drying and polishing cutlery, comprising: a support and containment structure having a port for loading cutlery to be dried and polished and a port for unloading dried and polished cutlery; a treatment tank that has a circular plan shape, with a bottom and with a substantially vertical axis and is adapted to contain a drying and polishing material, said treatment tank being supported elastically at said support and containment structure, being actuatable with a vibrating motion and being connected to said loading and unloading ports; and a rising channel, that is provided internally to said tank and is arranged helically around said axis from the bottom of said treatment tank to said unloading port, said loading port being spaced laterally from said axis of said treatment tank.

2. The machine of claim 1, wherein said treatment tank has a substantially cylindrical shape, is open in an upper region thereof, and is delimited by a bottom wall, by an outer cylinder that forms a cylindrical wall, and by an inner cylinder; said outer cylinder and said inner cylinder protruding, coaxially to each other, from said bottom wall of the treatment tank; said rising channel being arranged between said outer cylinder and said inner cylinder.

3. The machine of claim 2, wherein said treatment tank has: an inlet, formed in a region of the cylindrical wall thereof and connected to said loading port; and an outlet, which is formed in a region of a cylindrical surface thereof that is proximate to an upper end of the tank and is connected to said unloading port.

4. The machine of claim 3, comprising a loading duct connected to the cylindrical wall of said treatment tank, said loading port being connected to said inlet by way of said loading duct.

5. The machine of claim 4, wherein said loading duct has a flat bottom that is substantially co-planar with respect to the bottom of said treatment tank and is blended laterally with the cylindrical wall of said treatment tank by way of a wall portion thereof that is arranged on a plane that is substantially tangent to the cylindrical wall of said treatment tank.

6. The machine of claim 4, wherein said loading port is connected to said loading duct by way of a hopper.

7. The machine of claim 6, wherein said support and containment structure is substantially shaped like a parallelepiped, said loading port being formed in an upper wall of said support and containment structure.

8. The machine of claim 6, wherein said support and containment structure is substantially shaped like a parallelepiped, said hopper with said loading port being connected to a side wall of said support and containment structure.

9. The machine of claim 6, wherein said unloading port is formed in a front wall of said support and containment structure.

10. The machine of claim 9, wherein said unloading port is formed in an upper central region of said front wall.

11. The machine of claim 10, wherein said front wall of the support and containment structure has a flap that is tiltable up below said unloading port, in order to form a supporting surface for a cutlery collecting container exiting from said unloading port.

12. The machine of claim 6, wherein an end portion of said rising channel is at least partially perforated and lies on a plane that is substantially perpendicular to the axis of said treatment tank.

13. The machine of claim 12, comprising a fan supported proximate to said end portion of said rising channel, said fan being operatable so as to blow with a stream of air, orientated away from said outlet, cutlery and drying and polishing material arranged on said end portion of the rising channel.

14. The machine of claim 13, comprising heating means for heating the drying and polishing material.

15. The machine of claim 14, wherein said heating means comprise an electric resistor that is arranged in said treatment tank.

16. The machine of claim 15, wherein said electric resistor is arranged below said perforated end portion of the rising channel, above a level of the drying material.

17. The machine of claim 14, further comprising sterilizing means for sterilizing the cutlery and the drying and polishing material.

18. The machine of claim 17, wherein said sterilization means comprises an ultraviolet lamp that faces said treatment tank in an upward region thereof.

19. The machine of claim 1, wherein at least machine parts that make contact with the cutlery are made of stainless steel.

20. The machine of claim 1, wherein at least machine parts that make contact with the cutlery are made of, and/or coated with, a material suitable for contact with food products.
